(19) United States
(12) Patent Application Publication
(10) Pub. No.: US 2010/0197807 A1
(43) Pub. Date: Aug. 5, 2010

(54) COMPOSITIONS COMPRISING REACTION PRODUCTS OF ALKYLAMIDOAMINES, ALKYLAMINOIMIDAZOLINES AND FREE AMINE AND THEIR USE

(75) Inventors: Sabine GIESSLER-BLANK, Dortmund (DE); Juergen Ballandies, Essen (DE); Ute Linke, Mettmann (DE)

Correspondence Address: FROMMER LAWRENCE & HAUG, 745 FIFTH AVENUE- 10TH FL., NEW YORK, NY, 10151, US

(73) Assignee: Evonik Goldschmidt GmbH, Essen (DE)

(21) Appl. No.: 12/695,796

(22) Filed: Jan. 28, 2010

(30) Foreign Application Priority Data
Jan. 30, 2009 (DE) 102009000505.6

(51) Int. Cl. A01N 25/00

(52) U.S. Cl. 514/772.7; 514/772.3

(57) ABSTRACT

Compositions comprising reaction products of alkylamidoamines, alkylaminoimidazolines and free amine and also processes for their preparation and their use as solvents in agrochemical formulations.

This application claims benefit under 35 U.S.C. 119(a) of German patent application DE 102009000505.6, filed on Jan. 30, 2009.

Any foregoing applications including German patent application DE 102009000505.6, and all documents cited therein or during their prosecution (“application cited documents”) and all documents cited or referenced in the application cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

The invention relates to the use of special fatty acid reaction products consisting of alkylamidoamines, alkylaminoimidazolines and free amine as solvent with a crystallization-inhibiting effect.

Agrochemical active ingredients for crop protection, but also for applications in the non-crop sector are mostly offered in special formulations in order to ensure simple handling. The non-crop sector includes, for example, landscaping, house and garden applications such as, for example, pest control, lawn treatment, such as, for example, on golf courses, and also the protection of wood.

The type of formulation is influenced by the cultivated plant, the cultivated area and also the user. On account of the multitude of physicochemical properties of the various pesticide active ingredients, there are a large number of different liquid but also solid types of formulation on the market. Formulation additives give rise to certain application properties such as retention, penetration, rain resistance and spreading behaviour. By virtue of a special formulation, it should be ensured that the lowest possible amount of active ingredient can be distributed evenly over a large area (reduction in the application amounts for protecting the consumer and the environment), but at the same time continuing to ensure maximum performance and effectiveness.

Irrespective of the type of formulation, for use, all pesticide formulations are diluted with water and sprayed on targets (with amounts of water of 50-1000 l/ha).

An important type of formulation for agrochemical active ingredients is the emulsion concentrate (EC). When creating an EC formulation, the starting point is the selection of a suitable solvent or solvent mixture. This should be toxicologically and ecologically acceptable and should have a low flammability. It is a further requirement to find a suitable emulsifier for this system so that the dilution with water for the spray application remains stable for a sufficiently long time.

Agrochemical emulsions should remain stable for at least 24 hours, but better 48 hours, without creaming or sedimentation.

However, also active ingredients are also used which, upon contact with water, have a tendency towards crystallization and thus making spraying extremely difficult. Consequently, it is also necessary to avoid the agrochemical active ingredient from crystallizing out. In spray devices which are usually used for applying aqueous formulations of crop treatment compositions, several filters and nozzles are present. While applying aqueous spray mixtures based on pesticide active ingredients, specially finely meshed nozzles in the micrometer range can become more or less readily blocked by the active ingredient which is crystallizing out.

Resistance of the pesticide-containing active ingredient composition to premature crystallizing out over the course of 48 hours following contact with water or in the spray mixture should be ensured.

A subgroup of emulsion concentrates are microemulsions which consist of an oil component, a large fraction of one or more emulsifiers, at least one pesticide, and small amounts of water and/or other additives. On account of the presence of water, there is a high requirement here for the solvent to keep the pesticide in solution. Microemulsions are preferably suitable for insecticides.

A decisive factor here is the dissolving capacity of a solvent for a substance. The dissolving capacity is fulfilled if the solvent is able to convert the dissolved substance into a true solution from which the dissolved substance and the solvent can be recovered in a chemically unchanged form. Within the context of this invention, not only is the influence on true solutions considered, but also on emulsions, as are often present in pesticide or insecticide compositions. The active substance must be kept in solution or emulsion and must not show crystallization, sedimentation or creaming effects.

What was acceptable in the past is nowadays no longer conceivable. There are high requirements on the formulation technology and the additives used, primarily because the call to reduce drift is becoming ever greater and there are therefore higher requirements as to the nozzles that can be used.

Chemical or biological crop protection compositions (also called pesticides below) or pesticide mixtures are used. These may be, for example, herbicides, fungicides, insecticides, growth regulators, molluscicides, bactericides, viridicides, micronutrients and biological crop protection compositions based on natural substances or living or treated and/or processed microorganisms. These substances can be used on their own or in any desired mixtures with one another.

Pesticide active ingredients are listed in conjunction with their fields of use e.g. in “The Pesticide Manual”, 14th edition, 2006, The British Crop Protection Council; biological active ingredients are given e.g. in “The Manual of Biocontrol Agents”, 2001, The British Crop Protection Council.

DE-3910921 (U.S. Pat. No. 5,369,118) discloses the use of N-allyllactanes and EP-A1-0453899 (U.S. Pat. No. 5,206,225) discloses the use of alkylcarboxylic acid dimethylamides as crystallization inhibitors for triazoles and azole derivatives.

US-2008/0255127 describes the use of alkoxylated alkylmonoethanolamides and phosphates for the active ingredients just mentioned.

Said patents and applications include formulations based on N-methylpyrrolidone (NMP). In the meantime, NMP has been prohibited in a number of southern European countries on account of its toxicology (there is a danger of the product having a toxic effect on foetuses, being absorbed through the skin) for use in agrochemical formulations, and in additional other countries it is a topic under discussion and is largely avoided. Consequently, a very good solvent for many pesticide active ingredients has disappeared from the market. Moreover, said documents use only monoamines as raw materials, not polyethylenepolyamines, which would be necessary for the formation of imidazolines.

WO-2007/028382 (US 2009-0137649) discloses triazole formulations consisting of esters of vegetable oils, water-soluble polar cosolvents and water-immiscible cosolvents. This combination of various, very different surface-active substances makes the formulatability very complex on account of interactions between the components themselves, but also with the pesticide active ingredients, and also hinders and impairs the stability of the formulations themselves.

### OBJECT OF THE INVENTION

Nowadays, there are high requirements on the formulation technology. Especially for active ingredients which, upon contact with water, have a tendency towards crystallization and greatly hinder spraying, these requirements can often not be met.

Thus, despite the great attention given specifically to triazole formulations (of which in particular tebuconazole and flutriafol have a tendency towards crystallization), there continues to be a need for toxicologically and ecologically acceptable solvents. Moreover, these solvents should have a low flammability and exhibit a crystallization-inhibiting effect. This behaviour should be applicable not only to triazoles (i.e. fungicides), but generally to pesticides which have a tendency towards crystallization, thus also insecticides e.g. those based on pyrethroids or herbicides.

Moreover, since for emulsion concentrate formulations (ECs) in most cases a large fraction of emulsifiers is required in order to be able to prepare the formulation in the form of a spray mixture, it would be desirable if the oil and/or solvent, as main component of the EC, have emulsifying properties so that formulations with the smallest possible number of additives can be prepared. Due to compatibility reasons for a formulation it is always desired to use as less components as possible.

### Solution:

Surprisingly, it has now been found that special reaction products of fatty acid and polyethylenepolyamines and compositions prepared therewith, comprising alkylamidoamines, alkylamino-imidazolines and free amine, have a preferred dissolving capacity for various agrochemical active ingredients so that these do not crystallize, specifically upon contact with water but also in the formulation during the long storage time of more than two years (depending on market requirements). This dissolving capacity is dependent on the molar ratio of the starting materials, the starting substances and the reaction time and also the reaction temperature.

This object is achieved by compositions according to the invention comprising reaction products of a) monobasic carboxylic acids with a straight-chain, optionally branched hydrocarbon radical having 1 to 29 carbon atoms which possibly comprises multiple bonds and/or substituents, b) with fatty amines, imidazolines, polyamines, quaternary ammonium compounds, but specifically tetraethylenepentamine and/or N-alkyltetraethylenepentamine and/or N,N-dialkyltetraethylenepentamine and/or pentaethylenehexamine or higher polymines and/or derivatives thereof, by a process known per se. The resulting reaction products have a mixture of alkylamidoamines, alkylaminoimidazolines and free amine in the compositions.

Alkylaminoimidazolines are only stable if amines with more than three amine groups, thus e.g. diethylenetriamine, are used. Such reaction products are known from EP-1283239 A1. However, the use as adhesion promoter for bituminous compounds is limited and not proposed for agrochemical formulations. Moreover, in the meantime, diethylenetriamine residues which are used for such reactions have been classified as toxic, harmful to the environment and corrosive and should therefore not be used in high concentrations for the use specifically for agrochemical purposes, specifically as solvents. The solvent effectiveness of the reaction products based on diethylenetriamine, moreover, is worse than that of the reaction products according to the invention which have a substantially higher amine number.

### Preparation of the Compositions According to the Invention:

In general, fatty acid or fatty acid ester and amine are combined in the molar ratio 0.6:1 to 1.45:1 and heated under an inert gas atmosphere with stirring to a reaction temperature of ca. 140-200° C. and the resulting condensate (water or alcohol) is distilled off continuously. Towards the end of the reaction, a subatmospheric pressure can be applied to remove excess amine and residues of condensate.

An example of the alkylaminoamine of the invention is depicted by the compounds of formulae (1) and (2) and an example of the alylamidoimidazoline of the invention is depicted by the compound of formula (3) below:

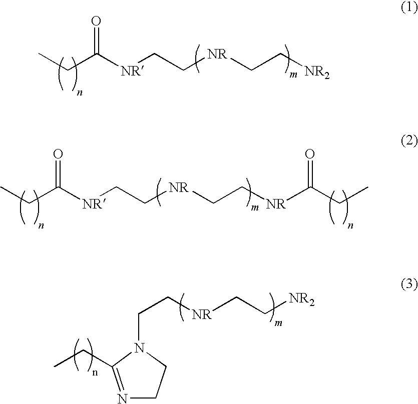

It is known to the person skilled in the art that to prepare compounds of the formulae (1) and (2), the reaction is advantageously carried out at the lowest possible temperatures around ca. 140 to 180° C. If the reaction temperatures are increased, e.g. to 210° C., the reaction times and, if appropriate, the vacuum phase are extended, predominantly compounds of the general formula (3) are obtained.

It has been found that a dynamic equilibrium is present between the open-chain compounds of the formulae (1) and (2) and the ring compound of the formula (3). This has been confirmed by quantitative ¹³C-NMR spectroscopic investigations. The distribution is dependent on the degree of conversion, the molar ratio of the components used, and the temperature. Moreover, depending on the molar ratio, free amine is present at up to 28 mol %. The free amine is determined by extraction.

In the formulae (1) to (3),
R and/or R′, independently of one another, are identical or different groups from a hydrogen radical or an alkyl group having 1 to 18 carbon atoms, which may be linear or branched, optionally also further substituted, R′ is preferably a hydrogen radical or a methyl group,
m is 2 to 10 and
n is selected from the group consisting of 1 to 29, 2 to 28 and 3 to 26, where the formed carbon radical may be saturated or unsaturated, including mono-, di- or triunsaturated, and may also be further substituted with further functional groups.

Mixtures of different substances of the formulae (1) or (2) or (3) may also be present.

At amine numbers of <380 mg KOH/g, the molar ratio of products of the formulae (1) and (2) to products of the formula (3) is about 1:99 to about 25:75, the remainder consists of free amine. Alternatively, the molar ratio of products of the formulae (1) and (2) to products of the formula (3) is selected from the ranges selected from the group consisting of about 5:95 to about 12:88 and about 20:70.

Consequently, in the reaction product, i.e. without the addition of water and further adjuvants, as are used for agrochemical compositions, the compositions according to the invention have an amine number of >270 mg KOH/g.

The compositions according to the invention have a mass ratio between alkylamidoamines and alkylamino-imidazolines in the ratio of from 0.125:1 to 0.35:1.

In an example of the compositions according to the invention, the mixture of alkylamidoamines, alkylaminoimidazolines and free polyethylenepolyamine has a content of free amine of a range selected from the group consisting of greater than 0.01% by weight, greater than 1% by weight and greater than 3% by weight. In another embodiment of the invention the content of free amine is less than about 20% by weight. In yet another embodiment of the invention, the content of free amine is less than about 15% by weight.

Fatty acids which are used for the preparation of the reaction products with amines underlying this invention are—alone or in mixtures—fatty acids such as acetic acid, propionic acid, butyric acid, caproic acid, caprylic acid, capric acid, resin acid, 2-ethylhexanoic acid, lauric acid, myristic acid, myristoleic acid, palmitic acid, palmitoleic acid, isostearic acid, stearic acid, hydroxystearic acid (ricinoleic acid), dihydroxystearic acid, oleic acid, linoleic acid, petroselic acid, elaidic acid, arachic acid, gadoleic acid, behenic acid, erucic acid, clupanodonic acid, lignoceric acid and cerotic acid, melissic acid and the technical-grade mixtures that are produced during the pressurized cleavage of natural fats and oils, such as oleic acid, linoleic acid, linolenic acid, and in particular rapeseed oil fatty acid, soya oil fatty acid, sunflower oil fatty acid, coconut fatty acid and/or tall oil fatty acid (the term tall oil alone is also used synonymously). In principle, all fatty acids with a similar chain distribution are suitable.

One embodiment of the invention is given to using relatively long-chain fatty acids having 8 or more carbon atoms, such as, in particular, the acids occurring in natural fats and oils.

Another embodiment of the invention is given to using partially hydrogenated C_{8/18}-coconut and/or palm fatty acids, rapeseed oil fatty acids, sunflower oil fatty acids, soya oil fatty acids and tall oil fatty acids, and in particular technical-grade C_{8/18}-coconut fatty acids, where, if appropriate, a selection of cis/transisomers, such as C_{16/18}-fatty acid cuts rich in elaidic acid, may be advantageous. In principle, monobasic carboxylic acids with a straight-chain, optionally branched hydrocarbon radical having 1 to 29 carbon atoms which possibly comprises multiple bonds and/or substituents are preferred.

The amines used for the preparation of the reaction products with fatty acids underlying this invention are tetraethylenepentamine and/or N-alkyltetraethylene-pentamine and/or N,N-dialkyltetraethylenepentamine, substituted or unsubstituted pentaethylenehexamine or higher polyamines and/or derivatives thereof. The alkyl group is determined by branched or unbranched C₁ to C₁₈-alkyl groups, the unbranched alkyl groups being preferred, and in particular methyl, ethyl, propyl, butyl, pentyl, hexyl or dodecyl groups, for example, being used in the stated amines.

Surprisingly, for the compositions according to the invention it was found that sometimes no conventional emulsifier (such as e.g. alkylsulfonates, polyoxy-ethylene-fatty acid esters, polyoxyethylene-sorbitan trioleates or fatty acid monodiglycerides) was necessary to obtain an emulsifiable and stable formulation.

The prepared emulsions were stable at least over a period of 48 hours without oil settlement, creaming or some other type of sedimentation taking place. It is therefore assumed that the combination of the compositions according to the invention and a polyether copolymer and/or an alkoxylated siloxane and/or other wetting agents suffices for self-emulsifiability. Instead of the specified siloxane, it is also possible to use other wetting agents such as trisiloxanes (for example such as BREAK-THRU® S 240 or BREAK-THRU® S 278 from Evonik Goldschmidt GmbH) or alkoxylated polyethers.

One subject matter of the invention is thus compositions which comprise further adjuvants and/or wetting agents.

In particular, a further subject matter of the invention is a composition which, instead of a polysiloxane, such as, for example, BREAK-THRU® OE 441, uses trisiloxanes and/or alkoxylated polyethers as wetting agents.

Further subject matters of the invention are the use of the compositions according to the invention in pesticide formulations for crop protection and also non-crop applications, and also the pesticide formulation itself. In one embodiment of the invention, the pesticide formulations comprise 30-70% by weight, 35-65% by weight or 44-60% by weight of the compositions according to the invention in the agrochemical formulations.

A subject matter of the invention is likewise the use of the compositions according to the invention in pesticide formulations which are based on microemulsions or emulsion concentrates.

The dissolving capacity of the compositions according to the invention should turn out such that 1-40% by weight of one or more pesticides, or 5-27% by weight, can be held in solution. Here, as additive to the compositions underlying the invention, it is also possible to admix further mineral-oil-based cosolvents. These are preferably based on Solvesso® 150 (Exxon) or Hydrosol® A 200 ND (DHC Solvent Chemie GmbH) and have a naphthalene content of greater than 2% by weight. The use of less than 5% by weight of glyceryl oleates (or dioleates) may likewise prove advantageous. These include, for example, products from Evonik Goldschmidt GmbH: Antil® 171 (a glyceride, coco-mono- and di-, ethoxylated) or Antil® 120 (a PEG-120 methyl glucose dioleate).

Further embodiments or subject matters of the invention arise from the claims, the disclosure of which is in its entirety part of this description.

The examples below are intended to illustrate the present invention in more detail without limiting the scope of protection which arises from the description and the patent claims.

The compositions according to the invention are described below by way of example without any intention to limit the invention to these exemplary embodiments. Where ranges, general formulae or compound classes are given below, these are intended to include not only the corresponding ranges or groups of compounds explicitly mentioned, but also all part ranges and part groups of compounds which can be obtained by removing individual values (ranges) or compounds.

Where documents are cited within the context of the present description, then their content should be deemed in its entirety as belonging to the disclosure of the present invention. Where, within the context of the present invention, compounds, such as e.g. polymeric carrier materials, acids or esters, are described which can have different substructures or formula units several times, then these may be present in these compounds in random distribution (random oligomer) or in an arranged manner (block oligomer). Data relating to the number of units in such compounds are to be understood as meaning an average value, averaged over all of the corresponding compounds. Percentage data are to be understood as being based on the weight unless explicitly stated otherwise.

In the analytical investigations undertaken for the purposes of determining the degree of conversion, amine numbers of about 270-600 mg KOH/g were determined.

The testing of the amine number was carried out according to the indicator method in accordance with ISO 4315. For this, bromophenol blue (Merck) was used to identify the transition point during titration with 0.1 N HCl from blue to green. The method serves generally to determine the amine number in fatty amines. It is determined by titrating the amine with a standardized acid against an indicator. The amine number (AN) indicates the mg of KOH which correspond to the basicity of 1 g of sample, therefore corresponding values are given in mg KOH/g.

The invention is further described by the following non-limiting examples which further illustrate the invention, and are not intended, nor should they be interpreted to, limit the scope of the invention.

### EXAMPLES

### Application Tests

### A) Testing the Resistance to Crystallization:

To test the crystallization properties, in each case ca. 2 l of an aqueous solution which comprises a concentration of 0.5-1% by weight of an agrochemical formulation are circulated in a flow apparatus with the help of a pump for 8 hours through a finely meshed sieve with a mesh width of 100 mesh (corresponding to 150 nm, e.g. from Graco). The solution, including the finely meshed sieve, are left to stand overnight at room temperature and are not changed, the circulation test is continued on the next morning for further 8 hours. Consequently, the spray mixture is subjected to a 24 hour test during which the solution is circulated for 16 hours and rests for 8 hours. When the test is complete, both solution and sieve are investigated for crystals using a microscope.

The test is deemed to have been passed if less than 10% of the sieve is covered with crystals. As a further test, seed crystals were added to a formulation which was then stored at 6° C. For this formulation crystal growth was visually checked by microscope every day.

As a further suitability test of the formulation, the CIPAC test MT 36.3 was carried out.

The agrochemical formulation which was used for test purposes has the following composition: 25% by weight of active ingredient (tebuconazole (calculation the purity of the active to 100%)), 5% by weight of BREAK-THRU® OE 441 (an alkoxylated polysiloxane from Evonik Goldschmidt), 10% by weight of Solvesso 150 (Exxon) or 10% by weight of Hydrosol A 200 ND (DHC Solvent Chemie GmbH), 10% by weight of BREAK-THRU® DA 646 (a polyether copolymer from Evonik Goldschmidt), 50% by weight of a composition according to the invention.

What is striking with this formulation is that no conventional emulsifier (such as e.g. alkylsulfonates, polyoxyethylene-fatty acid esters, polyoxyethylene-sorbitan trioleates or fatty acid monodiglycerides) was required to obtain an emulsifiable and stable formulation. The prepared emulsion was stable at least over a period of 48 hours without oil settlement, creaming or some other type of sedimentation taking place.

### 1) Example According to the Invention

Tall oil fatty acid (from Arizonal Chemical B.V.) and tetraethylenepentamine (from Aldrich) are used in a molar ratio of 0.8:1.2 and reacted for 1 hour at 180° C., then for 3 hours at 210° C.

The reaction product is characterized by a density of ca. 0.931 g/cm³ (25° C., in accordance with DIN 51757), an amine number of 540 mg KOH/g and a viscosity of 170 mPas (25° C., in accordance with DIN 53015). The acid number (analyzed in accordance with DIN EN ISO 2114) is 1.4 mg KOH/g. The acid number (AN) indicates the number of mg of KOH which is required to neutralize the free acids present in 1 g of product.

In the mixture of the reaction products, the components analogous to formulae 1-3, analyzed by ¹³C-NMR and extraction, are present as follows:
1 Fatty acid amide linear (1) and (2) ca. 16% by weight
2 Fatty acid amide cyclic (3) ca. 65% by weight
3 Free amine (tetraethylenepentamine) ca. 19% by weight.

The reaction product characterized in this way was used to create an agrochemical formulation based on tebuconazole, as described above, with 50% by weight and was subjected to a crystallization test. After 24 hours, the crystallization test exhibited no wetting of the mesh filter with crystals and is therefore deemed to have been passed.

The formulation is equivalent in its biological effectiveness to a known commercially available formulation.

### 2) Comparative Example

Tall oil fatty acid (from Arizonal Chemical B.V.) and tetraethylenepentamine (from Aldrich) are used in a molar ratio of 1.2:0.8 and reacted for 1 hour at 180° C., then for 3 hours at 210° C.

The reaction product is characterized by an amine number of 270 mg KOH/g.<3% by weight of free amine are present. The acid number (analyzed in accordance with DIN EN ISO 2114) is 2.4 mg KOH/g. The reaction product characterized in this way is used to create an agrochemical formulation based on tebuconazole, as described above, with 50% by weight and is subjected to a crystallization test.

The crystallization test shows that more than 10% of the mesh filter was occupied with crystals. Likewise, in the EC formulation itself, crystals were detected after storage for about 1 month at room temperature, i.e. the dissolving capacity of these reaction products was inadequate for tebuconazole.

### Field Trials Results Brazil:

Inventive tebuconazole formulations, as described in the patent application under section crystallisation stability, (which are based on the example according to the invention derived reaction product with an amine number of 540) were tested in Campinas, Sao Paulo State of Brazil for the control of soyabean rust, and were compared with a commercial tebuconazole formulation of BayerCropScience Brasil (Folicur SC 200 g ai/l). GW 1554 contains 7 wt-% Break-thru® OE 441 (a polysiloxane, GW 1555 contains instead 7 wt-% Break-thru® S278 (a trisiloxan and superspreader. The Comparison shows the influence of the adjuvant. For the test the soyabean cultivar “Codetec 214” was planted on December 12 on the Agro Cosmos Experimental Farm. The whole test area was conducted under adequate agronomic practices in terms of plant spacing, plant population, chemical control of weeds and insects. Due to sufficient and good distributed rainfall it was not necessary to irrigate plots.

A block completely randomized design was used with four replications and plot sizes of six rows of soyabeans 5 m long with a total area of 15 m² (3×5 m). The plots were sprayed using the equivalent of 200 l/ha water to which the test products and the commercial standards were added. The comparison of the formulations was done on a gram active ingredient dose per ha of 100 and 50 g a.i./ha.

The chemical applications were done with backpack equipment with constant pressure provided by CO2. A boom with six Teejet XR 11002 flat fan nozzles was used with each nozzle over a soyabean row during the spraying. One application of the test compounds was done on February 4, when the soyabeans were at R2 (full flowering) growth stage. By the time of spraying the plants were 60-70 cm high and 95% of the plants showed first soyabean rust pustle on the bottom leaves, caused by the fungus Phakopsora pachyrhizi. After the application of the test compounds, several assessments of the soybean rust severity were done of which the assessment at 21 days and 35 days after application are shown in the table of results (table 1). Evaluations in each plot included two procedures: one at the field and one at the laboratory. In the field, form each plot 10 leaflets of the central leaflet of the leaf from different plants were collected at the bottom ½ of the plant canopy and 10 from the top ½ of the canopy. This provided 20 leaflets from each plot. The collected samples were transported to the lab the same day of collection in a polystyrene box with ice at a temperature of 7 to 8 degree C. From the field to the lab it took about 30 minutes. In the lab the 20 samples of each plot were placed on a negatoscop (this equipments provides fluorescent light under the leaflet) with the abaxial facing to the observer because the disease is present on this surface of the leaves. Soyabean rust in each leaflet was evaluated by comparison with a standard that indicates % of leaf area infested with soyabean rust. The infection ratings of the 20 leaves were added and then an average was calculated which was taken as one value per plot. From the 4 replications per treatment a mean was calculated, and the 4 values per treatment was also used to run ANOVA statistical analysis for significant differences at 95% probabilities. At each timing of evaluatiuon, the field collection and lab assessment was completed in one day.

The data of results are shown in table 1. It is clear from the results that the inventive formulations performed significantly better than the commercial standard when comparing the same rates of active ingredient in gram per hectare.

TABLE 1

| | |
|---|---|
| | Infected leaf area (%)¹ |
| A.I. dose | with soyabean rust after |

| Treatment | g/ha | 21 days | 35 days | |
|---|---|---|---|---|
| Folicur standard | 100 | 2.5 c | 13.5 | c |
| | 50 | 4.3 b | 18.1 | b |
| GW1554 | 100 | 1.4 g | 6.7 | f |
| | 50 | 1.9 e | 9.1 | e |
| GW1555 | 100 | 1.8 f | 8.9 | e |
| | 50 | 2.2 d | 10.5 | d |
| Control: Untreated | | 6.7 a | 33.6 | a |

¹Numbers with the same letter behind them are statistically not different at P = 0.05 (ANOVA)
A.I. = active incredient

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. A composition comprising the reaction product of
a) one or more monobasic carboxylic acids with a straight-chain, optionally branched hydrocarbon radical having 1-29 carbon atoms which optionally comprises multiple bonds and/or further substituents, with
b) polyethylenepolyamine
by a process known per se, where the reaction takes place for at least 1.5 hours at temperatures>200° C.,
and an agrochemical active ingredient.

2. The composition according to claim 1, comprising components according to the formulae (1), (2) and (3) 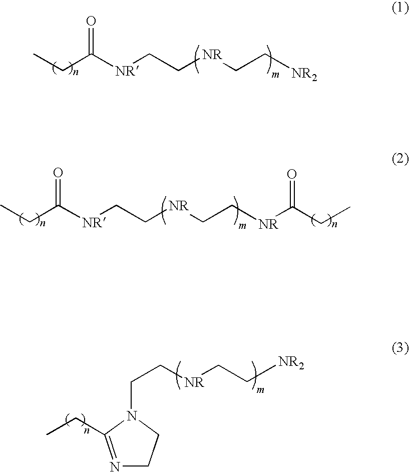
where
R and/or R′, independently of one another, are identical or different groups from a hydrogen radical or an alkyl group having 1 to 18 carbon atoms, which may be linear or branched, optionally also further substituted,
m is 2 to 10 and
n is 1 to 29, where the formed carbon radical may be saturated or unsaturated, including mono-, di- or triunsaturated, and may also be further substituted with further functional groups.

3. The composition according to claim 1, characterized in that the reaction products comprise alkylamidoamines, alkylaminoimidazolines and free amine.

4. The composition according to claim 1, characterized in that the dissolving capacity of the compositions suffices to keep 1 to 40% by weight of one or more pesticide actives in solution.

5. The composition according to claim 1, characterized in that the reactants a) and b) are used in a molar ratio of 0.6:1 to 1.45:1.

6. The composition according to claim 1, characterized in that they have, as reaction product, an amine number of >270 mg KOH/g.

7. The composition according to claim 1, characterized in that alkylamidoamines and alkylaminoimidazolines are present in the mass ratio of from 0.125:1 to 0.35:1.

8. The composition according to claim 1, characterized in that a mixture of alkylamidoamines, alkylaminoimidazolines and free polyethylenepolyamine has a content of free amine of >0.01% by weight.

9. The composition according to claim 1, characterized in that tetraethylenepentamine and/or N-alkyltetraethylenepentamine and/or N,N-dialkyltetraethylenepentamine, substituted or unsubstituted pentaethylenehexamine or higher polyamines and/or derivatives thereof are used as polyethylenepolyamine.

10. The composition according to claim 1, characterized in that acetic acid, propionic acid, butyric acid, caproic acid, caprylic acid, capric acid, resin acid, 2-ethylhexanoic acid, lauric acid, myristic acid, myristoleic acid, palmitic acid, palmitoleic acid, isostearic acid, stearic acid, hydroxystearic acid (ricinoleic acid), dihydroxystearic acid, oleic acid, linoleic acid, petroselic acid, elaidic acid, arachic acid, gadoleic acid, behenic acid, erucic acid, clupanodonic acid, lignoceric acid and cerotic acid, melissic acid and also the technical-grade mixtures produced during the pressurized cleavage of natural fats and oils, such as oleic acid, linoleic acid, linolenic acid, rapeseed fatty acid, partially hydrogenated C_{8/18}-coconut or palm fatty acids, soya oil fatty acid, sunflower oil fatty acid, coconut fatty acid and/or tall oil fatty acid are used as component (a).

11. The composition according to claim 1, characterized in that tall oil fatty acid is used as component (a) and tetraethylenepentamine is used as component (b).

12. The composition according to claim 1, comprising further adjuvants and/or wetting agents.

13. The composition according to claim 12, characterized in that tri- and/or polysiloxanes or alkoxylated polyethers are present as wetting agents.

14. Process for the preparation of compositions according to claim 1, characterized in that the reaction of the components (a) and (b) takes place at temperatures >200° C. for at least 1.5 hours.

15. A method of making a pesticide composition which comprises of adding a composition according to claim 1 to a composition for crop protection or non-crop application.

16. The method of claim 15, wherein the pesticide composition is based on microemulsions or emulsion concentrates.

17. Pesticide formulation comprising a composition according to claim 1.

18. The method of claim 15, wherein the pesticide composition comprises 30-70% by weight of the composition of claim 1.
